(19) United States
(12) Patent Application Publication
(10) Pub. No.: US 2007/0246366 A1
(43) Pub. Date: Oct. 25, 2007

(54) Composite Oxygen-Permeable Membrane

(76) Inventors: Vladimir Zalmanovich Mordkovich, Moscow (RU); Dmitry Nikolaevich Kharitonov, Moscow (RU); Alexandr Konstantinovich Avetisov, Moscow (RU); Yulu Kivovich Baichtok, Moscow (RU); Ekaterina Dmitrievna Politova, Moscow (RU); Nataliya Vladimirovna Dudakova, Moscow (RU); Sergei Vyacheslavovich Suvorkin, Elektrostal (RU); Gennady Vladimirovich Kosarev, Moscow (RU)

Correspondence Address: United Research and Development Centre LLC, Leninsky pr-t, 55/1-2, Moscow, 119333, RU

(21) Appl. No.: 11/666,109

(22) PCT Filed: Oct. 17, 2005
(86) PCT No.: PCT/RU05/00510

§ 371 Date: Jul. 9, 2007

(30) Foreign Application Priority Data
Oct. 25, 2004 (RU) 2004130965

(51) Int. Cl. B01D 71/02

(52) U.S. Cl. 204/627

(57) ABSTRACT

The proposed composite oxygen-permeable membrane comprises a solid ceramic layer with ion and/or electron conductivity and at least one layer of gas-permeable structure made of an alloy containing elements of groups VIII and VI of Mendeleev's Periodic Table and aluminum. In specific implementations the gas-permeable layer is made of an alloy comprising iron, chromium and aluminum. Additionally a task of creating mechanically stable protecting layers is accomplished by selecting holes of various forms and sizes, in particular, in the form of pores and meshes. The invention is aimed at extending the life term of membrane reactors, in particular, reactors for oxygen recovery from an oxygen-containing gas and for the reaction of hydrocarbons oxidation.

### CROSS-REFERENCE TO RELATED APPLICATIONS

This application is a U.S. national phase application of a PCT application PCT/RU2005/000510 filed on 17 Oct. 2005, published as WO2006046886, whose disclosure is incorporated herein in its entirety by reference, which PCT application claims priority of a Russian Federation patent application RU2004130965 filed on 25 Oct. 2004.

### FIELD OF THE INVENTION

This invention relates to the area of membrane technologies and concerns separation of gases at membranes, in particular, at selective gas-tight membrane, specifically for separation of oxygen-containing gases to recover oxygen and to use the oxygen recovered in reactions of oxidative conversion of hydrogen-rich gases, e.g. for producing syngas from methane.

### BACKGROUND OF THE INVENTION

Oxidative conversion of hydrocarbon gases with application of oxygen-permeable membranes is a promising direction of gas processing development. Today the most commonly used method for hydrocarbon gas conversion is steam conversion at elevated pressures (15-40 bar) and temperatures (800-850° C.) [Spravochnik azotchika, 2^{nd} edition, revised. Moscow, Chemistry, 1986, 512 p. (in Russian)]. Disadvantages of this method include high energy consumption for reactor heating and for generation of high-pressure steam.

Conversion of hydrocarbons with application of partial oxidation methods allows almost complete exclusion of energy consumption for reactor heating, moreover, the generated heat can be utilized [Spravochnik azotchika, 2^{nd} edition, revised. Moscow, Chemistry,1986, 512 p. (in Russian)].

However, the use of air as an oxygen-containing gas results in the necessity of further utilization of nitrogen and other components of air. Accordingly, there is an arising need to use either expensive cryogenic systems enabling nitrogen separation from the products of conversion, or a unit for preliminary separation of air to produce oxygen. In any case, separation of gas mixture aimed at recovering nitrogen is the most expensive stage in the process of partial oxidation.

Introduction of technology for membrane separation of air with oxygen-permeable membrane allows significant (up to 30%) reduction of energy consumption and capital cost in syngas production and hence products costs, including the cost of hydrogen.

An important advantage of the membrane process is also the possibility of module design of a reactor capable of providing easier scale-up production.

An oxygen-permeable membrane used in the process of membrane-assisted conversion is a ceramic plate or tube or a structure of another convenient form. The membrane has sufficient oxygen permeability at predeterminedly high temperatures typical for the partial oxidation of the hydrocarbon gas. At the same time, the membrane is gas-tight, that is manufactured from nonporous material.

The membranes used for air separation possess ion or mixed electron-ion conductivity. In both cases, ions of oxygen, driven by a gradient of partial pressure, come through a dense nonporous membrane at a predeterminedly high rate and with essentially absolute selectivity.

The process of membrane-assisted conversion of hydrocarbon gases, in particular methane, is commonly designed as follows: oxygen-containing gas (for example, air) is fed at one side of a tubular membrane (e.g. outside the membrane), hydrocarbon gas (e.g. methane) is fed at the other side (inside the membrane, respectively). When methane is used, the following reactions take place in the space inside the membrane:
CH₄+3O₂=CO₂+H₂O,
CH₄+CO₂=CO+H₂,
CH₄+H₂O=CO+3H₂,
   which results in formation of syngas that is a mixture of hydrogen and carbon oxide (with high selectivity—up to 90%).

Continuous consumption of oxygen in the oxidation reaction ensures the required difference in partial pressures of oxygen at both sides of the membrane. As oxygen is transferred exclusively by the ionic mechanism, the obtained syngas does not contain nitrogen.

Application of gas-tight oxygen-permeable membranes in the process of oxidative conversion of methane into syngas is a radical improvement of existing technologies for hydrocarbon conversions, resulting in improved efficiency and simplified processes. The key element of this technology is a ceramic membrane, which provides for oxygen transfer to the zone of reaction.

Complex oxide compounds with ion and/or electron conductivity and a “perovskites” structure are known to be the most promising materials for manufacturing gas-tight membranes for oxygen separation from oxygen-containing mixtures, in particular, from oxygen-rich gases. The rates of 1.5-2.5 Nm³/m²sec are commercially applicable and sufficient for oxygen diffusion from air or other oxygen-containing gases through such membranes. To achieve such rates, the thickness of the perovskite membrane should not exceed 15-30 μm, which makes the membrane mechanically inadequate for practical use.

To make this membrane mechanically stable for practical use, it is protected from one or two sides with mechanically stable gas-permeable layer chemically or adhesively linked with the membrane. Porous ceramics or metal alloys of various compositions and various forms are usually used as such material. Complex structures formed in this way are called “composite membranes”.

U.S. Pat. No. 5,599,383 describes composite membranes comprising thin layer of dense oxygen- and electron-conductive ceramics having structure of perovskite with a thickness of 0.01 to 500 μm, a layer of porous ceramic support made of material selected from a group consisting of metal oxides, such as aluminum, cerium, silicon, magnesium, titanium, high-temperature oxygen-containing alloy stabilized with zirconium, or their mixtures. To make this membrane mechanically stable it is supported on a porous metallic substrate.

A disadvantage of the known membranes is their insufficient stability due to a difference of thermal expansion coefficients of the membrane and the protecting gas-permeable layer(s).

The nearest prior art device to the present invention is a composite membrane known from U.S. Pat. No. 5,935,533, which comprises a solid layer of gas-tight oxide ceramics possessing ion and/or electron conductivity, for example with the structure of perovskite, a layer of porous substrate made of high-temperature steel, containing nickel and chromium, which is located on one or both sides of ceramics, and an inter-phase zone of gradient composition (buffer layer) located between the said layers of ceramics and substrate.

A disadvantage of this technical solution is insufficient stability of the membrane due to the difference in thermal expansion coefficients of steel and ceramics.

Another disadvantage of the known technical solution is the ambiguity of composite membrane properties related to the existence of an intermediate buffer layer with a thickness of at least 5 μm, which has an uncertain changing in the time composition, as this buffer layer is formed, as a result of diffusion into ceramics of at least one element of the alloy containing nickel and chromium.

### SUMMARY OF THE INVENTION

This inventive solution is proposed to eliminate or substantially reduce the aforementioned drawbacks and disadvantages of the prior art technologies by means of creation of a composite oxygen-permeable membrane possessing high stability and having optimum characteristics of gas-tightness and oxygen-permeability.

The solution results in reduction of the difference in the linear expansion coefficients of a protecting gas-permeable layer and a ceramic layer, and in prevention of the diffusion of particles of the used alloy into the ceramic layer, which jointly result in enhanced stability of the ceramic layer connection with the layer of gas-permeable structure, including the stability manifested at predeterminedly high temperatures and temperature differences.

The technological result is achieved by the fact that in the composite oxygen-permeable membrane containing a solid ceramic layer with ion and/or electron conductivity and at least one layer of gas-permeable structure made of an alloy containing elements of groups VIII and VI of Mendeleev's Periodic Table, the alloy additionally containing aluminum is used for said gas-permeable layer. Providing the gas-permeable layer of alloy, which additionally contains aluminum, smoothes the difference in linear expansion coefficients and, along with this, plays a role of protecting a barrier excluding the diffusion of metal atoms from the alloy into the ceramics. These both factors result in enhanced stability of the ceramic layer connection with the layer of gas-permeable structure, especially at predeterminedly high temperatures, which is manifested in maintaining integrity of such connection.

In a particular case of this invention implementation, the composite oxygen-permeable membrane comprises two layers: a first layer that is solid and made of ceramic possessing ion or mixed electron-ion conductivity, and a second layer that is gas-permeable and made of steel alloy containing iron, chromium and aluminum. In another particular case of this invention implementation, the composite oxygen-permeable membrane comprises three layers, that is, two layers of gas-permeable structure made of alloy containing elements of groups VIII and VI of Mendeleev's Periodic Table, and a solid ceramic layer located between them possessing ion or mixed electron-ion conductivity.

In one more particular case, said layer of gas-permeable structure has holes of various forms and sizes. Said layer of gas-permeable structure can also include pores or meshes.

### BRIEF DESCRIPTION OF THE DRAWINGS

FIG. 1 is an isometric sectional view of a tubular composite membrane, according to an embodiment of the present invention.

FIG. 2 is an orthogonal sectional view of a flat (planar) composite membrane, according to an embodiment of the present invention.

FIG. 3 is a diagram of the rig for measuring oxygen permeability of gas-tight membranes, according to an embodiment of the present invention.

### DESCRIPTION OF PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

According to the invention, a composite oxygen-permeable membrane is made by applying a first solid ceramic layer over a second gas-permeable layer made of an alloy containing elements of groups VIII and VI of Mendeleev's Periodic Table. Methods for applying a gas-tight perovskite layer over the gas-permeable layer (or substrate) are selected based on the geometry of the composite membrane to be prepared and conditions of its application. Such known methods as pressing, deposition from solutions by the sol-gel technology, chemical vapour deposition, laser or plasma spraying, coating with centrifuging, etc. are used as methods for perovskite application. A geometrical shape of the membrane is determined by the mode of its application: the membrane can be flat, tubular, corrugated, etc.

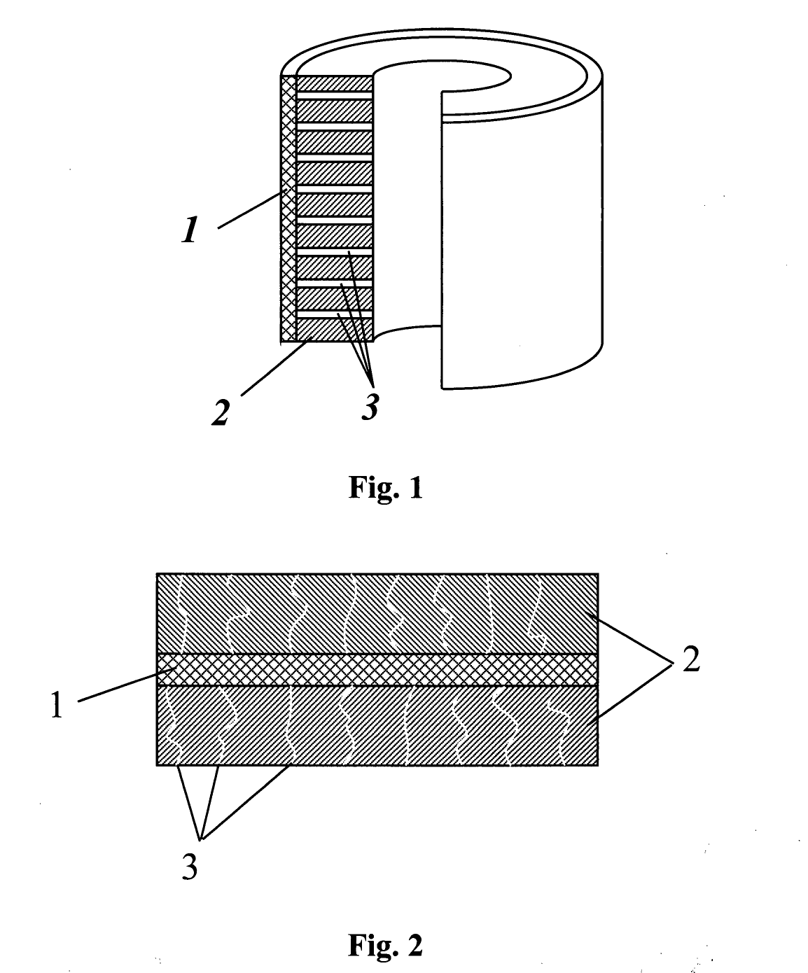

For instance, the composite oxygen-permeable membrane is made in the form of tubes (see an example illustrated in FIG. 1) or in the form of plates (see an example illustrated in FIG. 2).

The chemical composition of a protective metal porous layer(s), as well as the shape of the pores, their size and location are selected in such a way that to avoid damage of integrity of the gas-tight membrane during the heating due to the difference between the thermal expansion coefficients of the gas-tight membrane and the protective gas-permeable layer(s).

In the invention, this is achieved by using an alloy containing elements of groups VIII and VI of Mendeleev's Periodic Table and aluminum.

In a particular case of this invention implementation shown in FIG. 1, a tubular composite membrane has an external layer (1), which is a gas-tight oxygen- and electron- conducting ceramic membrane, and an internal layer (2), which is a gas-permeable protecting metal layer with holes (3).

In another specific case of this invention implementation (FIG. 2), a flat (or planar) composite membrane is presented, comprising two gas-permeable protective metal layers (2) with pores (3), and gas-tight oxygen- and electron permeable ceramic membrane (1) located between the metal layers.

According to the invention, a composite membrane can be used for gas separation, in particular oxygen-containing gases, for oxygen recovery and oxygen use in reactions of oxidative conversion of the hydrocarbon gas, for example, in syngas production from methane.

For this purpose, in particular, the composite membrane is sealed in a conversion reactor in such a way that this membrane divides reactor space into two parts. The oxygen-containing gas is fed into one part, and methane is fed into the other, reacting with oxygen separated from the gas mixture downstream the membrane with syngas formation.

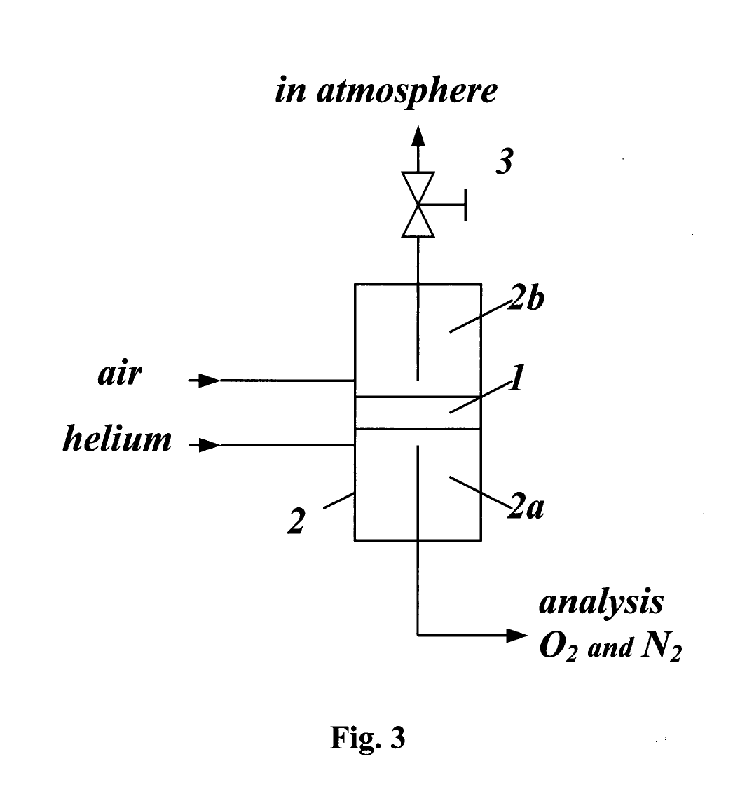

To determine performance characteristics of the composite membrane, such as oxygen permeability and gas tightness, tests are carried out, for example, deploying a measurement rig, a functional diagram of which is shown in FIG. 3. The rig for oxygen permeability measurement for gas-tight membranes comprises a line for oxygen-containing gas feeding, in particular air, a line to supply helium (e.g. additionally purified from oxygen traces), a measuring cell (2) with two chambers: a first chamber (2a) and a second chamber (2b) separated by a membrane (1), wherein air is fed to the first chamber, and purified helium is fed to the second chamber, a fine-metering valve (3) and a system (not illustrated) to analyze the helium downstream outlet from cell (2) for oxygen and nitrogen content in the gas mixture permeated through the composite membrane.

Cell (2) is performed as a hollow metal vessel. Composite membrane (1) is disposed in cell (2), and fixed therein. The membrane should be fixed in such a way that it divides cell (2) into two chambers: the aforesaid chamber (2a) for the helium flow (which helium is preliminary purified in an absorber with metallic copper heated up to 200° C.—not illustrated), and the aforesaid chamber (2b) for the airflow. The pressures on both sides of membrane (1) in cell (2) are equalized with fine-metering valve (3). The gas leaving chamber (2a) of cell (2) is drawn to the analysis system to determine the content of nitrogen and oxygen in this gas. This analysis is done by any known method, for example with chromatography or mass-spectrometry.

Implementation of this invention is illustrated by examples below, which are not intended to confine the scope of the invention specified by the claims, as the results obtained do not completely exhaust the scope of the carried out researches. In this particular case, as Examples show, alloys Fe—Cr—Al, Ni—Cr—Al, Co—W—Al, Ir—W—Al, Ru—Mo—Al were used to solve the tasks of this invention. cl EXAMPLE 1

A metallic foil with holes of diameter 50 μm, made of an alloy containing iron, chromium, and aluminum, is treated with organic solvent to remove mechanical impurities and/or high-boiling organic compounds from the foil surface; then it is heated during 3 hours up to the temperature of 1000° C.; held at this temperature for 3 hours; cooled down to the room temperature and an oxide composition is applied to the treated surface with the sol-gel method, this oxide composition includes such elements that it corresponds to the structure of perovskite. This sample is then heated again during 5 hours up to the temperature of 1200° C.; held at this temperature for 3 hours; and cooled down to the room temperature.

The composite membrane obtained in this way is placed into the aforesaid cell to check for gas tightness. The cell is heated during 2 hours up to the temperature of 850° C., held for 15 hours and cooled down to the room temperature. This operation is repeated three times with changing rates of heating and cooling down, as well as time of holding at elevated temperatures. During the whole test, the concentration of nitrogen in helium leaving the cell did not exceed 10⁻⁵ mole fractions proving the gas tightness of the composite membrane. At the same time concentration of oxygen in the flow changed depending on temperature from 10⁻⁵ to 10⁻¹ mole fractions proving oxygen-permeability of the composite membrane. Besides, on the ceramics there were no signs of phase degradation in the result of diffusion of protective layer material.

### EXAMPLE 2 (COMPARATIVE)

The experiment results, presented in Example 1, were repeated, except for using an alloy with no aluminum in the composition: stainless steel AISI 321H. The results of measuring the concentration of nitrogen in the helium flow leaving chamber (2a) of cell (2) (FIG. 3) indicated that the composite membrane is was not gas-tight. On the ceramic layer there were noticeable spots that was evidence of a phase degradation of the ceramic material.

These results prove the necessity of having aluminum in the composition of the metal alloy and its importance in ensuring gas-tightness of the composite membrane.

### EXAMPLES 3-11

The composite membrane is prepared by the method described in Example 1 with varying forms of making a mechanically stable protective layer, i.e. instead of a metallic foil with round holes, various types of the protective layer (metal substrate) are used. Results of gas-permeability tests for mechanically stable protective layer having holes of various forms and sizes, in particular, made in the form of porous foil or meshes are presented in the Table below.

TABLE
Gas-permeability tests of mechanically stable protective layer

| | | | | Max gas conc. | | |
|---|---|---|---|---|---|---|
| | | | | downstream | | |
| | | | Size of | membrane, | | Signs of |
| Example | | Type of | holes/pores, | mole fract. | | phase |
| No. | Alloy | protective layer | μm | O₂ | N₂ | degradation |
| 3 | Fe—Cr—Al | Porous foil | 0.1 | 5 × 10⁻² | <10⁻⁵ | no |
| 4 | Fe—Cr—Al | Porous foil | 1 | 9 × 10⁻² | <10⁻⁵ | no |
| 5 | Fe—Cr—Al | Foil with holes | 20 | 1 × 10⁻¹ | <10⁻⁵ | no |
| 6 | Fe—Cr—Al | Mesh | 30 | 7 × 10⁻² | <10⁻⁵ | no |
| 7 | Fe—Cr—Al | Mesh | 50 | 1 × 10⁻² | <10⁻⁵ | no |
| 8 | Ni—Cr—Al | Foil with holes | 50 | 1.5 × 10⁻¹ | <10⁻⁵ | no |
| 9 | Co—W—Al | Foil with holes | 50 | 1 × 10⁻¹ | <10⁻⁵ | no |
| 10 | Ir—W—Al | Foil with holes | 50 | 9 × 10⁻² | <10⁻⁵ | no |
| 11 | Ru—Mo—Al | Foil with holes | 50 | 8 × 10⁻² | <10⁻⁵ | no |

The data presented in the Table show that all the membranes tested as indicated in Examples 3-11, as well as in Example 1, are gas-tight and on the ceramic layer there are no signs of phase degradation as a consequence of diffusion of the protective layer material.

The results obtained in this research confirm the possibility of application of the inventive composite oxygen-permeable membrane in reactors operating at predeterminedly high temperatures and pressures with the aim of extending the lifetime of such membrane reactors, in particular, reactors for oxygen recovery from an oxygen-containing gas and for the reaction of hydrocarbons oxidation.

1. A composite oxygen-permeable membrane comprising a solid ceramic layer with ion and/or electron conductivity and at least one layer of gas-permeable structure made of an alloy including at least one element chosen from the groups VIII and VI of Mendeleev's Periodic Table, wherein said alloy additionally comprising aluminum.

2. The composite oxygen-permeable membrane of claim 1 wherein said alloy including iron as a group VIII element, and chromium as a group VI element.

3. The composite oxygen-permeable membrane of claim 1 wherein said at least one layer comprising two layers of gas-permeable structure and said solid ceramic layer disposed therebetween.

4. The composite oxygen-permeable membrane of claim 1 wherein said at least one layer of gas-permeable structure comprising holes.

5. The composite oxygen-permeable membrane of claim 1 wherein said at least one layer of gas-permeable structure made meshed.

6. The composite oxygen-permeable membrane of claim 1 wherein said at least one layer of gas-permeable structure made porous.
